(19) United States
(12) Patent Application Publication
(10) Pub. No.: US 2004/0003391 A1
(43) Pub. Date: Jan. 1, 2004

(54) Method, system and program product for locally analyzing viewing behavior

(75) Inventors: Srinivas Gutta, Yorktown Heights, NY (US); Subhash Kumar, Millwood, NY (US); Kaushal Kurapati, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/183,688

(22) Filed: Jun. 27, 2002

(51) Int. Cl. H04N 7/16; H04H 9/00

(52) U.S. Cl. 725/9

(57) ABSTRACT

The present invention provides a method, system and program product for locally analyzing (television) viewing behavior. Specifically, under the present invention, a single time interval of viewed programs is chunked into multiple time windows of viewed programs. Then, for each program within each time window, a conditional probability is calculated. The conditional probabilities are then compared to a noise threshold to determine recommended programs for each time window. The recommend programs can be added to a user profile and/or outputted to the viewer.

### BACKGROUND OF THE INVENTION

1. Field of the Invention

The present invention generally relates to a method, system and program product for locally analyzing viewing behavior. Specifically, the present invention allows a single time interval of television viewing behavior to be analyzed in smaller time windows so that accurate viewing recommendations can be made.

2. Background Art

As the use of cable and satellite television increases, television networks have increasingly provided viewers with an overabundance of programs. Such programs not only overwhelm the television viewers, but also make it difficult for the networks to analyze viewing behavior (e.g., determine what programs are likely to be watched). In addition, with the advancement of consumer electronic devices such as set-top boxes and hard-disk recorders, television viewers are being provided with more functionality. For example, many devices now allow a viewer to establish a user profile, from which viewing recommendations can be made. Moreover, many devices allow for tracking of the programs and/or program types that are being viewed. This type of information is commonly referred to as viewing history/behavior and is especially useful to television networks.

Heretofore, viewing behavior has been analyzed on a global basis. Specifically, the programs and/or program types that have been viewed over a single time interval (e.g., twelve months) are identified. Once identified, the frequency of viewing of each program is calculated. Based on the frequencies, viewing preferences can be determined.

Several problems exist, however, with analyzing viewing behavior globally. Specifically, many viewers do not watch programs with the same consistency during different time periods. For example, assume that a global single time interval is twelve months. Also assume that “baseball” related programs represented 97% of the viewed programs during the month of October, but only 3% of the viewed programs during the overall twelve month period (i.e., for a particular viewer). Unfortunately, under the global analysis, no attention would be paid to the high viewing frequency during October. Rather, the overall “global” percentage of 3% would be analyzed to determine the viewers' viewing preferences. Accordingly, the global analysis of viewing behavior can be an inaccurate way to measure a viewer's preferences.

In view of the foregoing, there exists a need for a method, system and program product for locally analyzing viewing behavior. Further, a need exists for a single time interval of programs to be chunked into multiple time windows of programs. Still yet, a need exists for a conditional probability for each program in each time window to be calculated. Moreover, a need exists for a noise threshold to be applied locally (e.g., to each conditional probability) so that particular programs can be recommended for each time window.

### SUMMARY OF THE INVENTION

The present invention generally provides a method, system and program product for locally analyzing viewing behavior. Specifically, under the present invention, a single time interval of viewed programs is chunked into multiple time windows of viewed programs. Then, for each program within each time window, a conditional probability is calculated. The conditional probabilities are then compared to a noise threshold to determine recommended programs for each time window. The recommend programs can be added to a user profile and/or outputted to the viewer.

According to a first aspect of the present invention, a method for locally analyzing viewing behavior is provided. The method comprises: (1) chunking a single time interval of viewed programs into a plurality of time windows of viewed programs; (2) calculating a conditional probability for each of the viewed programs of the plurality of time windows; and (3) comparing a noise threshold to the conditional probabilities to determine recommended programs.

According to a second aspect of the present invention, a method for locally analyzing viewing behavior is provided. The method comprises: (1) providing a single time interval of viewed programs; (2) chunking the single time interval into a plurality of time windows of viewed programs; (3) calculating a condition probability for each viewed program of each of the plurality of time windows; and (4) locally applying a noise threshold to each of the viewed programs to determine recommended programs for each of the plurality of time windows, wherein the calculated conditional probability for a particular viewed program of a particular time window must be at least equal to the noise threshold for the particular program to be a recommended program for the particular time window.

According to a third aspect of the present invention, a system for locally analyzing viewing behavior is provided. The system comprises: (1) a chunking system for chunking a single time interval of viewing programs into a plurality of time windows of viewed programs; (2) a probability system for calculating a conditional probability for each viewed program of the plurality of time windows; and (3) a threshold system for comparing a noise threshold to the conditional probabilities to determine recommended programs.

According to a fourth aspect of the present invention, a program product stored on a recordable medium for locally analyzing viewing behavior is provided. When executed, the program product comprises: (1) program code for chunking a single time interval of viewing programs into a plurality of time windows of viewed programs; (2) program code for calculating a conditional probability for each viewed program of the plurality of time windows; and (3) program code for comparing a noise threshold to the conditional probabilities to determine recommended programs.

Therefore, the present invention provides a method, system and program product for locally analyzing viewing behavior.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a recommendation system having an analysis system according to the present invention.

FIG. 2A depicts a single time interval of viewed programs according to previous systems.

FIG. 2B depicts time windows of viewed programs according to the present invention.

FIG. 3 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention generally provides a method, system and program product for locally analyzing viewing behavior. Specifically, under the present invention, a single time interval of viewed programs is chunked into multiple time windows of viewed programs. For each viewed program within each time window, a conditional probability is calculated. The conditional probabilities are then compared to a noise threshold to determine recommended programs for each time window. The recommend programs can be added to a user profile and/or outputted to the viewer.

It should be understood that as used herein, the term “program” could refer to a specific program (e.g., LAW AND ORDER), or a type/genre of program (e.g., crime dramas). To this extent, the teachings described herein are not intended to be limited to one particular interpretation of the term “program.”

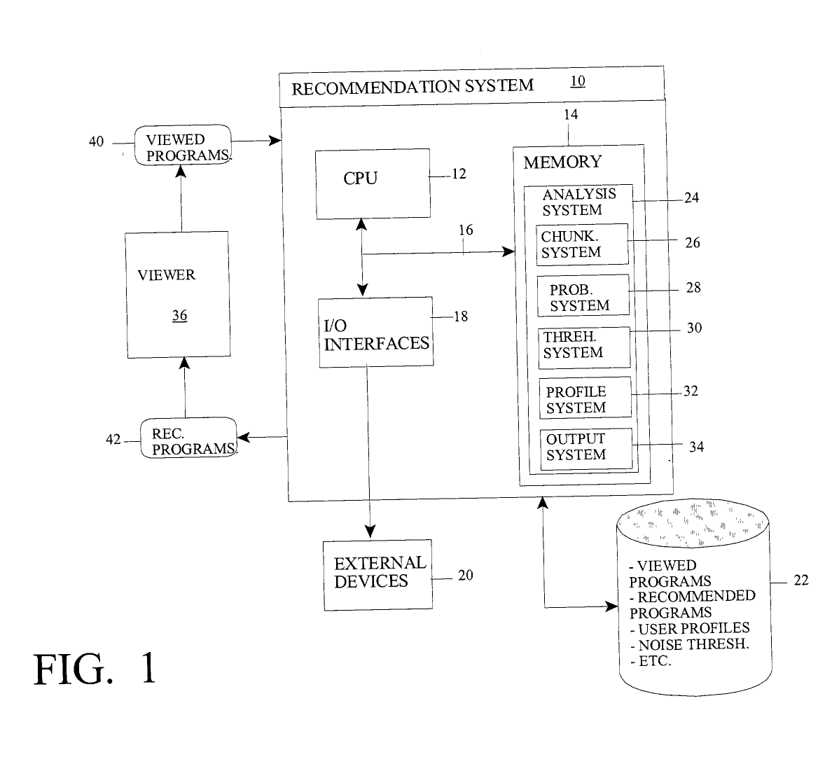

Referring now to FIG. 1, an exemplary recommendation system 10 is shown. In general, recommendation system 10 can be any computerized system that is capable of receiving user's/viewer's 36 viewing behavior and recommending programs 42 based on the local analysis thereof. To this extent, recommendation system 10 could be implemented in/as a set-top box or other consumer electronic device (e.g., hard-disk recorder, etc.). In addition, it should be understood that the term “viewing behavior” as used herein is intended to refer to programs 40 (i.e., specific shows or type of programs) viewed by viewer 36. As depicted, recommendation system 10 generally includes central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in recommendation system 10 and likewise may comprise any known type of transmission link, including electrical, optical, wireless, etc. In addition, although not shown, additional components, such as cache memory, communication systems, system software, etc., may be incorporated into recommendation system 10.

Database 22 may provide storage for information necessary to carry out the present invention. Such information could include, among other things, viewed programs, recommended programs, user profiles, noise thresholds, etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

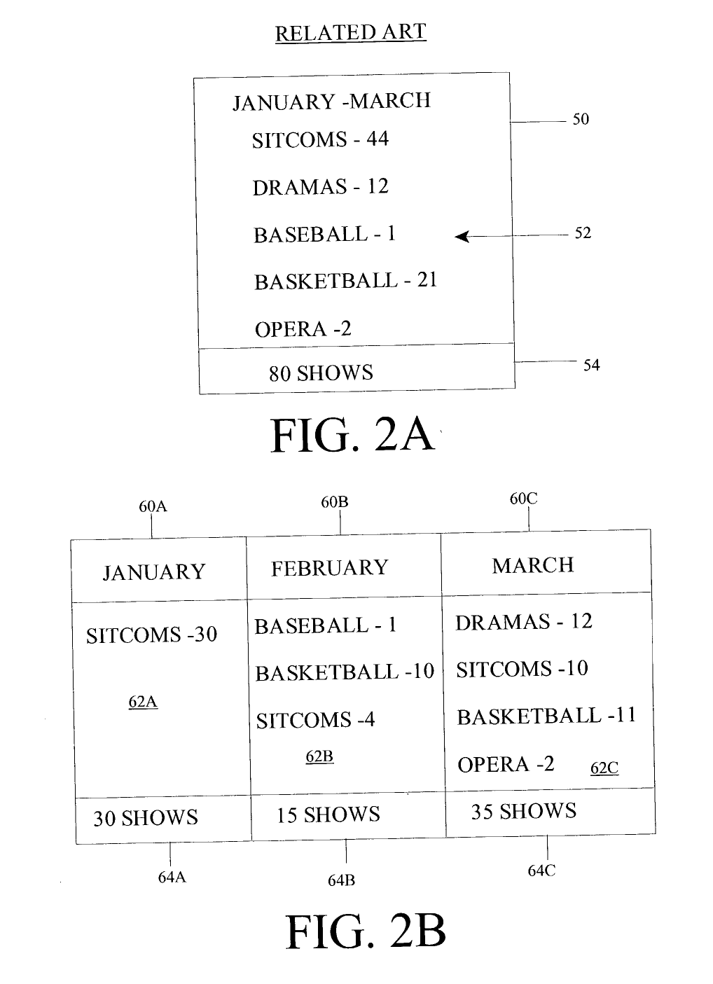

Stored in memory 14 of recommendation system 10 is analysis system 24 (shown as a program product). As depicted, analysis system 24 includes chunking system 26, probability system 28, threshold system 30, profile system 32 and output system 34. Under the present invention, chunking system 26 will chunk a single time interval of viewing behavior (i.e., viewed programs) into multiple time windows of viewed programs. Specifically, referring to FIG. 2A, a single time interval 50 of viewed programs 52 (shown as show/program types) is depicted. Under previous systems, viewing behavior was analyzed globally (i.e., over the entire interval). In the example shown, the single time interval is January through March. During this three month period, viewer 36 watched a total of eighty programs 54, broken down as shown. As indicated above, however, such global analysis is not always accurate because viewing behavior can change drastically with time. For example, the viewer watched two opera-related programs during time interval 50. Such viewing behavior represented only 2/80 or 2.50% of the total viewed programs. Because this percentage is so low, the likelihood that opera-related programs will be recommended to the viewer in the future is extremely low. This ignores the fact that opera-related programs might have actually represented 100% of all viewed programs during the month of January and, as such, might be worth recommending in the future.

To eliminate such failure, the chunking system 26 will “chunk” or split time interval 50 into smaller time windows, as shown in FIG. 2B. Specifically, three-month time interval 50 is chunked into three time windows 60A-C of programs 62A-C, with each window 60A-C representing one month's time. As depicted, viewer 36 watched thirty situation comedy programs during January time window 60A (e.g., FRASIER ten times, SEINELD eight times and DARMA & GREG twelve times). During February time window 60B, viewer 36 watched one baseball program, ten basketball programs, and four situation comedy programs for a total 64B of fifteen programs. Moreover, during March time window 60C, viewer 36 watched twelve drama programs, ten situation comedy programs, eleven basketball programs, and two opera programs for a total 64C of thirty-five programs. By chunking single time interval 50 into smaller time windows, a much more accurate viewing behavior can be determined.

It should be understood that chunking system 26 could be programmed to chunk any single time interval into multiple time windows in any manner. For example, time interval 50 could have been chunked into several week-long windows (as opposed to month-long windows).

Once the time interval 50 has been chunked into smaller time windows 60A-C, probability system 28 (FIG. 1) will determine the conditional probability for each program 62A-C in each time window 60A-C. As used herein, conditional probability refers to the percentage of times that a particular program was watched during a specific time window 60A, 60B or 60C. Specifically, to calculate a conditional probability for a particular program, the quantity of times the program was viewed (Qp) must be divided by the total quantity of programs viewed (Qt) during the respective time window 60A-C (Qp/Qt). For example, the conditional probability for basketball programs during January time window 60A is 0/30 or 0.00, during February time window 60B is 10/15 or 66.6%, and during March time window 60C is 11/35 or 31.4%. Accordingly, basketball-related programs might be worth recommending to viewer 36 during the months of February and March.

In determining what programs should be recommended to viewer 36, threshold system 30 will locally apply a noise threshold and determine recommendations based thereon. Specifically, the noise threshold will be applied to each program's conditional probability for the particular month. The noise threshold is typically some minimal level that a conditional probability must be at least equal to in order for programs related thereto to be recommended. For example, if the noise threshold is 4%, basketball-related programs will be recommended based on February and March viewing behavior only because those two windows 60B-C yielded a basketball conditional probability at least equal to 4% (i.e., 66.6% and 31.4%, respectively). Conversely, basketball was less than the noise threshold during January time window 60A, representing 0% of viewed programs.

It should be understood that the noise threshold of 4% used herein is exemplary only and any noise threshold could be implemented. Moreover, in recommending a program, any known algorithm could be implemented. For example, recommendations could be based on a previous months analysis. For example, viewing recommendations for April could include drama programs, situation comedy programs and basketball programs as well as opera programs (i.e., because the opera program's conditional probability during March time window 60C was only 2/35 or 5.71%). Alternatively, recommendations could be made for the same time window for a subsequent calendar year. For example, recommendations based on an analysis of March time window 60C could be made for March of the subsequent year. In any event, the present invention analyses viewing behavior locally, as opposed to globally.

If a program's conditional probability is at least equal to the noise threshold, the program could be added to viewer's 36 user profile by profile system 32. Specifically, as indicated above, many consumer electronic devices allow viewer 36 to establish a user profile for storage (e.g., in database 22). Such a profile could indicate personal information such as viewer's 36 name and age, as well as programming information such as what programs, actors, networks, and/or genres viewer 36 prefers. Under the present invention, profile system 32 will update viewer's 36 user profile based on the locally analyzed viewing behavior. This could be especially useful in the case where viewer's 36 preferences change but the user profile is not updated. For example, if viewer 36 had never expressed a preference for basketball-related programs, but current viewing behavior as locally analyzed indicates such a preference, viewer's user profile could be automatically updated to indicate as much.

In any event, regardless of whether the user profile is updated, output system 34 will output any recommendations to viewer 36. An indicated above, recommendations can be made according to any known manner. To this extent, the recommendations can be of a general or of a specific nature. In the case of the latter, specific programs could be recommended. For example, since viewer 36 has shown a strong tendency to view basketball-related programs, the specific program “NBA Finals Game 7 Saturday Night at 7:00 PM on XYZ network” could be outputted. To this extent, the recommendation could be made in the form of a display on viewer's television screen or any alternative manner.

As indicated above, the present invention could be applied similarly regardless of whether programs 62A-C are program types (as depicted in FIG. 2B) or specific shows. In the event that the programs are specific shows, recommendations based on a conditional probability of a particular show could be made for the same show or for similar shows. For example, if viewer 36 watched DARMA & GREG with a conditional probability of 50% during March time window 60C, future showings of DARMA & GREG could be recommended. Alternatively, other situation comedies (e.g., FRASIER) could be recommended. The precise form of recommendation is not intended to be limiting.

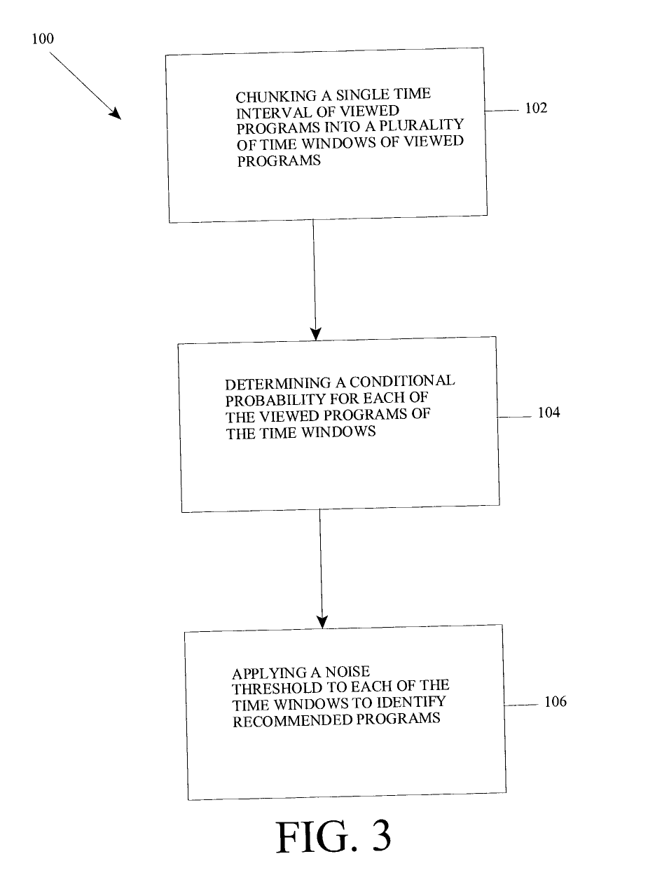

Referring now to FIG. 3, method flow diagram 100 according to the present invention is shown. As depicted, first step 102 is to chuck a single time interval of viewed programs into a plurality of time windows of viewed programs. Once chunked, second step 104 is to determine a conditional probability for each viewed program in each time window. Then, third step 106 is to apply a noise threshold to each program within each time window to identify recommended programs.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls recommendation system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the art.

1. A method for locally analyzing viewing behavior, comprising:
chunking a single time interval of viewed programs into a plurality of time windows of viewed programs;
calculating a conditional probability for each of the viewed programs of the plurality of time windows; and
comparing a noise threshold to each of the conditional probabilities to determine recommended programs.

2. The method of claim 1, further comprising providing a single time interval of viewed programs, prior to the chunking step.

3. The method of claim 1, wherein each conditional probability is calculated by the following steps:
determining a program viewing quantity for a particular viewed program during a particular time window;
determining a total viewing quantity for all viewed programs during the particular time window; and
dividing the program viewing quantity by the total viewing quantity.

4. The method of claim 1, wherein the viewed programs comprise program types or specific shows.

5. The method of claim 1, wherein the conditional probability for a particular viewed program of a particular time window must be at least equal to the noise threshold for the particular program to be a recommended program for the particular time window.

6. The method of claim 1, further comprising adding the recommended programs to a user profile.

7. The method of claim 1, further comprising outputting the recommended programs.

8. A method for locally analyzing viewing behavior, comprising:
providing a single time interval of viewed programs;
chunking the single time interval into a plurality of time windows of viewed programs;
calculating a condition probability for each viewed program of each of the plurality of time windows; and
locally applying a noise threshold to each of the conditional probabilities to determine recommended programs for each of the plurality of time windows, wherein the calculated conditional probability for a particular viewed program of a particular time window must be at least equal to the noise threshold for the particular program to be a recommended program for the particular time window.

9. The method of claim 8, further comprising adding the recommended programs to a user profile.

10. The method of claim 8, further comprising outputting the recommended programs.

11. The method of claim 8, wherein the locally applying step comprises comparing a noise threshold to each of the conditional probabilities to determine recommended programs for each of the plurality of time windows.

12. The method of claim 8, wherein each conditional probability is calculated by the following steps:
determining a program viewing quantity for a particular viewed program during a particular time window;
determining a total viewing quantity for all viewed programs during the particular time window; and
dividing the program viewing quantity by the total viewing quantity.

13. A system for locally analyzing viewing behavior, comprising:
a chunking system for chunking a single time interval of viewed programs into a plurality of time windows of viewed programs;
a probability system for calculating a conditional probability for each viewed program of the plurality of time windows; and
a threshold system for comparing a noise threshold to each of the conditional probabilities to determine recommended programs.

14. The system of claim 13, wherein each conditional probability is based on a quantity of times a particular program is viewed during a particular time window and a quantity of times all programs are viewed during the particular time window.

15. The system of claim 13, wherein the conditional probability for a particular viewed program during a particular time window must be at least equal to the noise threshold for the particular program to be a recommended program for the particular time window.

16. The system of claim 13, further comprising a profile system for adding the recommended programs to a user profile.

17. The system of claim 13, further comprising an output system for outputting the recommended programs.

18. A program product stored on a recordable medium for locally analyzing viewing behavior, which when executed comprises:
program code for chunking a single time interval of viewed programs into a plurality of time windows of viewed programs;
program code for calculating a conditional probability for each viewed program of the plurality of time windows; and
program code for comparing a noise threshold to each of the conditional probabilities to determine recommended programs.

19. The program product of claim 18, wherein each conditional probability is based on a quantity of times a particular program is viewed during a particular time window and a quantity of times all programs are viewed during the particular time window.

20. The program product of claim 18, wherein the conditional probability for a particular viewed program during a particular time window must be at least equal to the noise threshold for the particular program to be a recommended program for the particular time window.

21. The program product of claim 18, further comprising program code for adding the recommended programs to a user profile.

22. The program product of claim 18, further comprising program code for outputting the recommended programs.
